(19) United States
(12) Patent Application Publication
(10) Pub. No.: US 2025/0333200 A1
(43) Pub. Date: Oct. 30, 2025

(54) MULTIROLE DRONE ASSSEMBLY

(71) Applicant: DEFENDEYE Prosta Spólka Akcyjna, Polanka (PL)

(72) Inventors: James Buchheim, New York, NY (US); Weng Kheong Loh, Stillwater, OK (US); Piotr Michal Slawecki, Kraków (PL); Piotr Pawel Slonka, Bielany (PL)

(21) Appl. No.: 18/648,405

(22) Filed: Apr. 28, 2024

(51) Int. Cl. B64U 70/50; B64U 10/14; B64U 20/50; B64U 30/293; B64U 80/30; B64U 80/70; B64U 101/30; B64U 101/56

(52) U.S. Cl. CPC B64U 70/50; B64U 10/14; B64U 20/50; B64U 30/293; B64U 80/30; B64U 80/70; B64U 2101/30; B64U 2101/56; B64U 2201/10

(57) ABSTRACT

The present invention is a drone assembly for being used for multirole, first responders, and military applications. The drone assembly is formed from a drone and a launch tube therefor. In an un-deployed position of the drone assembly, the drone is stowed in a stowed position within the launch tube and the launch tube is closed. In a deployed position of the launch tube, the launch tube is open and the drone is peripherally exposed and capable of passing from an un-deployed position to a deployed position when the drone still rests in the launch tube. The drone comprises an onboard AI chipset and onboard sensors. The take-off and flight are performed autonomously. The launch tube relays the video images, sensor data and other telemetry information, via local Wi-Fi, and/or ethernet, cellular to a local or remote user or directly to be stored in a remote network system.

### FIELD OF THE INVENTION

The present invention relates to the field of drones, and more particularly to the field of self-deployed and autonomously operated multirole drones.

### BACKGROUND OF THE INVENTION

Drones are becoming an essential part of Armed Forces, Defense Forces, firefighters, marine rescue, security forces, agricultural survey, and the like. A drone, or an Unmanned Aerial Vehicle (UAV), allows its operator to have a bird's-eye view of the required area of interest, be it a burning building, a trapped car, hidden warriors, a floating person, a lost person in mountains or snow, a dry plantation, and the like. By the use of the drone's camera, the operator may see things that are beyond its normal line of sight.

The problems of flying drones and UAVs include, inter alia, high cost of the UAV or drone, time and cost for training an operator, time to prepare and launch a drone, including; finding a launch spot, unpacking, activating and waiting for GPS, and, need to identify a landing area. Since the landing of an UAV is sometimes a great challenge, fixed-wing UAVs have to be converted into a Vertical Take-Off and Landing (VTOL) aircraft. Even with VTOL capabilities, the operation may be challenging since a landing zone has to be identified, secured, and the landing itself may be challenging as well.

There are situations where the time to prepare and launch the drone may be critical. For example, if a drone has to be flown above a burning building, or, close to a person that has fallen from a sailing vessel, each second is critical, and, sometimes a preparing time of 5-10 minutes may be insufficient, unacceptable, and may cause loss of lives.

There are drones that are stored within a launch tube. When it is desired to launch the drone, in some cases an upper cover of the launch tube has to be opened in order to enable the ejection of the drone from the launch tube. In other cases, the upper cover is made of an easily torn material, and, without opening of the upper cover, the drone is ejected therethrough. Thus, the drone is forcibly ejected from within the launch tube by an ejection mechanism, a fact the increases the complexity of the launch tube and increases its price. Disadvantages of this launch method include: (1) due to the forced and quick ejection of the drone from within its launch tube, there is a danger of hitting a person or an obstacle, (2) due to the hitting hazard during the ejection from the launch tube, a relatively clear and wide launching site must be chosen, (3) after the ejection from the launch tube, the drone is forced to come immediately into a flight mode, otherwise, it will fall down. This fact might add complexity and design restrictions to the drone.

### SUMMARY OF THE INVENTION

The present invention includes a drone assembly/system for being used for multirole, first responders, and military applications.

According to the present invention there is provided a drone assembly comprising a drone and a launch tube therefor, wherein
in an un-deployed position of the drone assembly, the drone is stowed in a stowed position within the launch tube and the launch tube is closed,
in a deployed position of the launch tube, the launch tube is open and the drone is peripherally exposed and capable of passing from an un-deployed position of the drone to a deployed position of the drone when the drone still rests in the launch tube.

Typically, the drone comprises a generally cylindrical frame and a longitudinal axis, the frame comprises four beams that extend between a lower base and an upper base, an arm support is connected between each beam and the upper base, an arm is connected between each two adjacent arm supports, each arm is rotatable with respect to its adjacent arm supports around and arm axis that is perpendicular to a plane passing through the longitudinal axis and through the arm, wherein
in an un-deployed position of the drone, the arms are positioned parallel to each other and to the longitudinal axis, and
in a deployed position of the drone, the arms are perpendicular to the longitudinal axis.

Practically, each arm comprises, in an inward portion thereof, a toothed portion that extends at a sector of 90-degrees,
an operating pin is positioned between the toothed portions of the arms, the operating pin has a flat pin head and four toothed racks extending downwardly therefrom, each toothed rack conforms in shape and position to a toothed portion of an arm that is in contact therewith,
a tensioning bolt, having a bolt head and a threaded portion extending upwardly from the bolt head, is threadingly engaged into a lower portion of the operating pin,
an activating spring is compressed between the bolt head and the lower portion of the operating pin, wherein
in the deployed position of the launch tube, a tension of the activating spring urges the operating pin to a downward movement until the pin head abuts against the upper base of the drone, and wherein
during the downward movement of the operating pin, each of the four toothed racks rotates a mating toothed portion of an arm, and, each arm rotates a 90-degrees rotation about its arm axis, and the drone gets into a deployed position.

Advantageously, each arm comprises an electric motor, having a motor axis, and two propellers mounted thereon, and wherein
during a final deployment stage of the arms, an elevation force provided by the propellers to the deployed arms, and, a counter-weight provided by the drone, ensures a fully-deployment of the arms into a fully deployed position in which the arms are directed perpendicularly to a longitudinal axis of the drone, and each motor axis is parallel to the longitudinal axis.

Practically, the drone comprises at least one camera that provides video images and/or thermal video images.

Advantageously, the drone is provided with built-in AI for autonomously controlling launch, ascent, navigation, hovering, and descent to landing, and wherein
the built-in AI uses multiple sensors for navigation, including motion sensors for inertial navigation, camera looking at ground for optical flow, and object anchoring and identification for navigation.

Practically, the launch tube has a power switch and an arming and deployment switch that enables launching of the drone even if no mobile phone, computer, tablet computer, or laptop computer are connected or paired to the drone.

Further in accordance with the present invention there is provided a drone assembly comprising a drone and a launch tube therefor, wherein
the drone comprises an onboard AI chipset and onboard sensors, and wherein
the drone performs autonomously take-off and flight, searches for a pre-programmed target, and autonomously locate and identify specific targets that are detected via its onboard sensors.

Advantageously, the drone autonomously searches for humans, and upon finding a human it hovers above the human that was found.

If desired, in a case that more than one human was found, a decision to fly the drone to a next person will be done autonomously by the drone, or, by a person that is in control of video images received from the drone.

Practically, the drone autonomously searches for humans in specific programmed areas.

Further practically, the specific programmed areas include amongst others; shore lines, water strips beyond shore lines, one side of a fence or a wall, two sides of a fence or a wall, a perimeter of a given structure, trenches, specific buildings, and, a specific street.

If desired, the drone autonomously searches for fire and smoke, and upon detecting an area with fire or smoke, it hovers above the detected area or flies around it, for giving a 360-degrees thermal image of the detected area.

Still in accordance with the present invention there is provided a drone assembly comprising a drone and a launch tube therefor, the launch tube comprises a built-in long-range antenna that receives video images from the drone, and
the launch tube relays the video images, sensor data and other telemetry information, via local Wi-Fi, and/or ethernet, cellular to a local or remote user or directly to be stored in a remote network system.

Practically, the user is located remote from the drone assembly, and may see the video images, sensor data and other telemetry information, on a screen of a mobile phone, tablet computer, laptop computer, or PC.

Advantageously, the launch tube, serving as a relay station with built-in memory, can record or buffer the video images, so that if the user misses video images the launch tube can replay backwards the video images that are received from the drone and stored on the launch tube.

Practically, the launch tube and the drone utilize a fountain code or similar algorithm that allows to recover missing packets due to bad signal or conditions between the drone and the launch tube.

Advantageously, the drone is used for continuous observation for securing specific areas without taking-off from the launch tube.

Further advantageously, the specific areas that are observed may include, amongst others, border fences, wall, antenna towers, and strategic facilities.

Practically, the launch tube comprises:
a mirror that is located under a camera of the drone,
a transparent cover of the launch tube, positioned between the mirror and the area to be observed, and wherein
the camera is facing downwardly and provides video image of the area to be observed through the mirror.

If desired, the mirror is formed as an upwardly directed conical mirror having a vertex of the cone located below the camera,
the transparent cover of the launch tube extends around the conical mirror, between the conical mirror and the area to be observed, and wherein
the downwardly facing camera provides a video image of an area of 360-degrees or less, around the launch tube.

Practically, the launch tube and the drone utilize an encryption scheme, wherein
the drone has a stored root key,
when the drone is installed inside the launch tube by a user, the user will scan a barcode, or via local wireless on the drone, containing a public key or rotating keys, local wireless or a barcode of the launch tube also containing a rotating public key, and provisioning a combo specific launch tube and specific drone,
a cloud having public keys thereon will identify the specific public keys, compared to the public keys stored in the cloud, and root keys,
thus, a full encrypted rotating keys solution will be allowed, and wherein
the operation of the drone can be done only by connecting to the cloud and getting actual keys to decrypt a control of the drone.

Additionally, there is provided a method for securely provisioning a drone and a launch tube, using cloud-managed root keys, for ensuring secure initial setup and operational communication.

Further additionally, there is provided a system for encrypting and securely transmitting data from a drone, utilizing unique device-specific encryption keys managed centrally by a cloud service.

Still additionally, there is provided a communications and control module, for a drone launch tube, capable of multiple communication configurations: Configuration A—Wi-Fi to Wi-Fi configuration, Configuration B—Wi-Fi to Ethernet configuration, Configuration C—Wi-Fi to cellular configuration, Configuration D—Hybrid configuration.

Still yet if desired, there is provided a method of controlling drone launch and communication as described in configurations A, B, C, and D.

Additionally, there is provided a drone launch system comprising a launch tube, a drone, and the communications and control module.

### BRIEF DESCRIPTION OF THE DRAWINGS

Some embodiments of the present invention are herein described, by way of example only, with reference to the accompanying drawings. With specific reference to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

Attention is now directed to the drawings, where like reference numerals or characters indicate corresponding or like components. In the drawings:

FIG. 1 is a perspective view of a drone according to the present invention shown in a folded position;

FIG. 2 is a perspective view of the drone of FIG. 1 shown in an unfolded position;

FIG. 3 is a partial cross-sectional view of the drone of FIG. 1 taken in a plane passing through the longitudinal axis of the drone and through two oppositely positioned arms;

FIG. 4 is a partial cross-sectional view of the drone of FIG. 2 taken in a plane passing through the longitudinal axis of the drone and through two oppositely positioned arms;

FIG. 5 is a perspective view of a drone assembly according to the present invention shown in an un-deployed position;

FIG. 6 is a perspective view of the drone assembly of FIG. 5 shown in an intermediate stage of deployment, when the launch tube is open and the drone still rests on the launching platform; and

FIG. 7 is a perspective view of the drone assembly of FIG. 5 shown in a final stage of deployment, with the drone flying.

### DESCRIPTION OF PREFERRED EMBODIMENTS

The present invention includes a drone assembly that is usable in multirole application. The drone assembly 10 comprises a drone and a launch tube therefor.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Before explaining at least one embodiment of the invention in detail, it is to be understood that the invention is not necessarily limited in its application to the details of construction and the arrangement of the components and/or methods set forth in the following description and/or illustrated in the drawings and/or the examples. The invention is capable of other embodiments or of being practiced or carried out in various ways. Initially, throughout this document, references are made to directions such as, for example, upper and lower, left and right, and the like. These directional references are exemplary only to illustrate the invention and embodiments thereof.

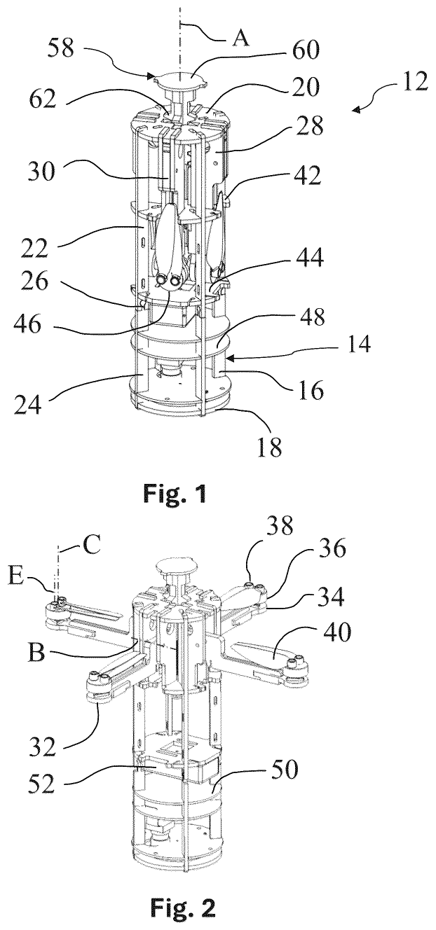

Attention is first drawn to FIGS. 1-4 that show a drone according to the present invention. As shown, a drone 12, having a longitudinal axis A, comprises a frame 14. Typically, the frame 14 is generally cylindrical in shape and is made mainly of wood and biodegradable plastic. According to a specific embodiment of the present invention, the frame 14 is made of 80% wood and biodegradable plastic. Thus, the drone 12 is cost-effective and can be used for a single-use and then disposed away.

The frame 14 comprises four wooden beams 16 that extend between a lower base 18 and an upper base 20. The beams 16 are parallel to each other and are equally distributed around the longitudinal axis A.

Each beam 16 comprises a beam upper section 22 and a beam lower section 24 that are connected to each other by an interlocking connection 26 (resembling a jigsaw puzzle piece connection). The initial construction of each beam 16 from two separate sections enables easy assembling of various parts of the drone 12. Upon assembling the various parts of the drone 12, the beam upper section 22 is permanently bonded, by applying an adhesive like super glue, to the beam lower section 24, for completing an assembly of the drone 12.

A wooden arm support 28 is connected between each beam 16 and the upper base 20. An arm 30 is connected between each two adjacent arm supports 28. Each arm 30 is rotatable with respect to its adjacent arm supports 28 around an arm axis B. For each arm 30, its arm axis B is perpendicular to a plane (not shown) passing through the longitudinal axis A and through the arm 30.

Each arm 30 comprises, in a free end 32 thereof, a motor mounting plate 34 that is connected to the free end 32 of the arm 30. An electric motor 36, that is rotatable around a motor axis C, is connected at a free end of the motor mounting plate 34. Each electric motor 36 has two spaced-apart upwardly directed protrusions 38. The protrusions 38 are upwardly directed when the arms 30 are in a fully deployed position of the arms 30. Each protrusion 38 has a protrusion axis E that extends parallel to the motor axis C. A propeller 40 is attached to each of the protrusions 38 such that it is freely rotatable with respect to the protrusion 38 around the protrusion axis E. In an un-deployed position of the arms 30, the two propellers 40 are adjacent to each other and extend upwardly.

An upper spacer 42, connected to each of the beams 16, is located below the arm supports 28. An intermediate spacer 44, connected to each of the beams 16, is located below a lowermost point 46 of the arms 30 when the arms are in a folded position. A lower spacer 48, connected to each of the beams, is located between the intermediate spacer 44 and the lower base 18. The lower spacer 48 has received thereon a control circuit 50 of the drone 12, and, a battery 52 for providing the required power for operation, control and flight.

As shown in FIG. 1, in a folded position of the drone 12, each of the propellers 40 extends upwardly from the protrusion 38 to which it is connected thereon, thus best utilizing a volume of the frame 14.

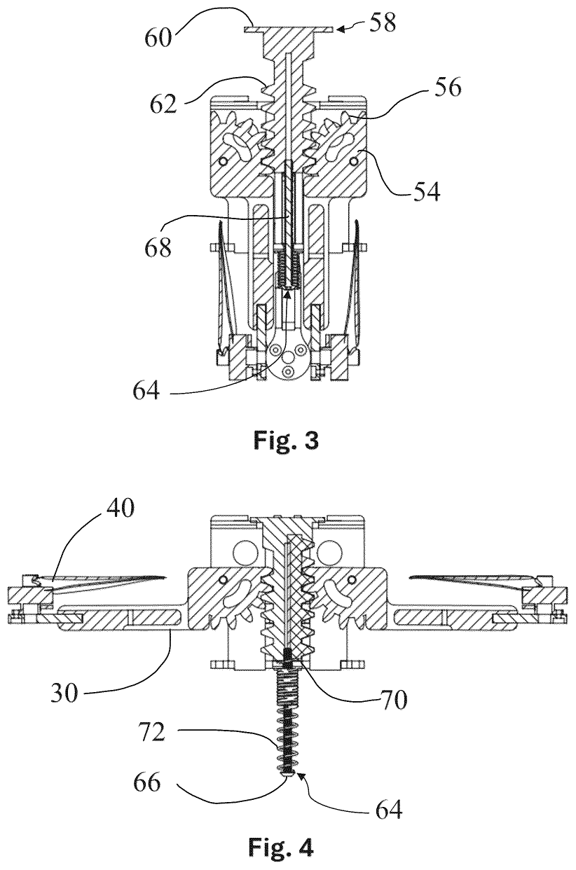

As shown in FIGS. 3 and 4, an inward portion 54 of each arm 30 that surrounds the arm axis B comprises a toothed portion 56 that extends at a sector of 90-degrees. An operating pin 58 is positioned between the toothed portions 56 of the arms 30. The operating pin 58 has a flat pin head 60 and four toothed racks 62 extending downwardly therefrom. Each toothed rack 62 conforms in shape and position to a toothed portion 56 of an arm 30 that is in contact therewith.

A tensioning bolt 64, having a bolt head 66 and a threaded portion 68 extending upwardly from the bolt head 66, is threadingly engaged into a lower portion 70 of the operating pin 58. An activating spring 72 is compressed between the bolt head 66 and the lower portion 70 of the operating pin 58. The purpose of the tensioning bolt 64 is to adjust the compression of the activating spring 72 so as to obtain a proper deployment of the arms 30, from a stowed position into a fully opened, or deployed, position. In a stowed position, the arms 30 are held downwardly folded, parallel to each other, as will be explained below, while urged by the activating spring 72 to get into a fully opened position when they are no longer held.

A camera 74 is positioned on the lower base 18. The camera 74 is facing downwardly and it may provide, through a dedicated aperture in the lower base 18, a regular video image or a thermal video image using combo camera or multiple cameras. In some cases, the drone 12 comprises one or more cameras (not shown) that are directed sideways so as to obtain an extra all-round view.

In a folded, or, stowed position of the drone 12, the drone 12 lies on a launching platform 76 of a launch tube 78. The launch tube 78 comprises an upper folding section 80, and, a lower avionic tube 82 positioned below the folding section 80.

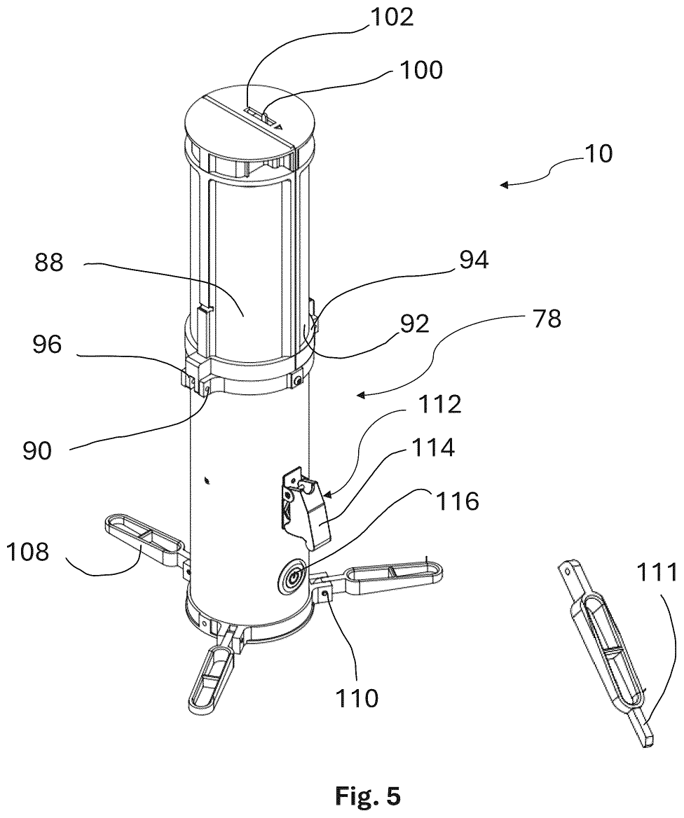

The upper folding section 80 comprises a first cap 84 that is attached to a second cap 86. In an attached position of the first cap 84 to the second cap 86, i.e., in an un-deployed position of the launch tube 78, the first cap 84 and the second cap 86 form a closed cylindrical container therebetween, as shown in FIG. 5.

The first cap 84 comprises, in a middle of a first cap lower portion 88 thereof, a first hinge 90 so that the first cap 84 is able to rotate about the first hinge 90 in a plane (not shown) that passes through the longitudinal axis A and through the first hinge 90. Similarly, the second cap 86 comprises, in a middle of a second cap lower portion 92 thereof, a second hinge 94, located diametrically opposite to the first hinge 90, so that the second cap 86 is able to rotate about the second hinge 94 in a plane (not shown) that passes through the longitudinal axis A and through the second hinge 94.

Each of the first hinge 90 and the second hinge 94 is provided with a torsional spring 96 that is loaded in an un-deployed position of the launch tube 78. Thus, the torsional spring 96 provided within the first hinge 90 enables a 180-degrees rotation of the first cap 84 around the first hinge 90 and away from the second cap 86. Similarly, the torsional spring 96 provided within the second hinge 94 enables a 180-degrees rotation of the second cap 86 around the second hinge 94 and away from the first cap 84.

As can be best seen in FIGS. 5-7, the first cap 84 is provided with a locking mechanism 98 to lock the first cap 84 with the second cap 86. The locking mechanism 98 has a locking arm 100 that engages into a corresponding locking groove 102 in the second cap 86. The locking arm 100 is operated by a servo motor 104. In an un-operated position of the servo motor 104, i.e., in a stowed mode, the locking arm 100 is engaged within the locking groove 102 and extending outwardly therefrom. Thus, it may be verified, both by eye observation or by physical contact, that the locking arm 100 is engaged within the locking groove 102, and hence, the first cap 84 is locked with the second cap 86 and the drone 12 may not be released, as shown in FIG. 5.

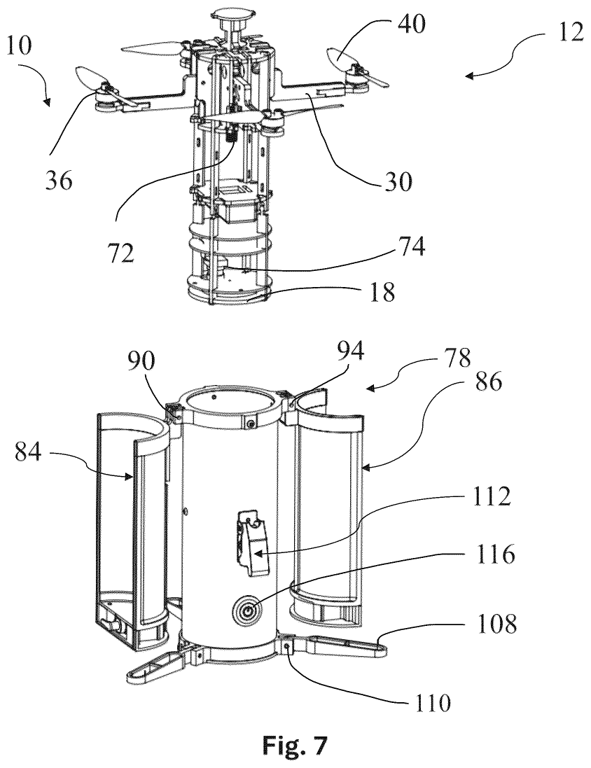

In an operation mode, or, release mode, the servo motor 104 receives a signal from a communications and control module 122, located within the launch tube 78, via a wire. When receiving the signal, the servo motor 104 operates the locking arm 100 which rotates a rotation of 90-degrees and out of the locking groove 102. At this position, the first cap 84 and the second cap 86 are no longer held together, and they separate apart by means of the pre-loaded torsional spring 96 found in each of the first hinge 90 and the second hinge 94. During a transit stage to an operation mode, as explained above, each of the first cap 84 and the second cap 86 accomplish a 180-degrees rotation about its corresponding hinge, until they get into a fully opened position as shown in FIG. 7.

The launch tube 78 is provided at a lower portion thereof with three, equally peripherally spaced, tripod legs 108. In a stowed position of the launch tube 78, the tripod legs 108 are folded upwardly in a direction that is parallel to the longitudinal axis A. In a deployed position of the tripod legs 108, the tripod legs 108 are deployed at a 90-degrees angle to a position that is perpendicular to the longitudinal axis A. In this position, the deployed tripod legs 108 add to the stability of the launch tube 78 on ground and prevent it from tipping over due to strong wind conditions.

Each tripod leg 108 rotates around a tripod hinge 110. Each tripod hinge 110 is made with a tight friction so that its corresponding tripod leg 108 may be positioned in any required angle with respect to the longitudinal axis A. Thus, if it is necessary, due to environment or landscape conditions, to tilt the launch tube 78 at an angle, generally small, with respect to a vertical direction, due to uneven or rocky surface, it may be done by deploying one or two tripod legs 108 to an angle that is greater than 90-degrees, measured from an upright position of the tripod legs 108, between the tripod legs 108 and the longitudinal axis A, thus elevating the launch tube 78 from the ground in the vicinity of the tripod leg 108 that was deployed more than 90-degrees.

In a case where it is required to fix the launch tube 78 on a soft soil, each of the tripod legs 108 is provided with a spike 111 (see FIG. 5) that extends lengthwise from the tripod leg 108. In that case, the tripod legs 108 are rotated to a 180-degrees angle with respect to the longitudinal axis A, until they extend downward, parallel to each other, so that they could by thrusted into ground thus keeping the launch tube 78 stable in the required position.

The avionic tube 82 comprises a power switch 112 for operating the power of the launch tube 78. The power switch 112 is typically of a rocker type and is provided with a protective cap 114 for preventing accidental operation of the power switch 112.

The avionic tube 82 comprises, generally located below the power switch 112, an arming and deployment switch 116 which is typically a press-type switch.

An antenna printed circuit board (PCB) 118 is attached under the launching platform 76.

The avionic tube 82 further comprises, located on a base plate 120 of the avionic tube 82, the communications and control module 122. An antenna 124 is connected between the antenna PCB 118 and the communications and control module 122. Also located on the base plate 120 is a launch tube battery 126 that is supported within a battery holder 128.

The launch tube 78 may be used as a portable launch tube 78 or as a stationary launch tube 78. In some embodiments, when the launch tube 78 is stationary, it is connected to a power supply that charges the launch tube battery 126, and, the battery 52 of the drone 12 through quick release charging points. When the launch tube 78 is portable, both batteries, i.e., the drone battery 52 and the launch tube battery 126, which are rechargeable, may last 6-12 months in a charged state before they have to be recharged, typically by a charger connected to the launch tube 78 through a USB port.

In order to operate the drone 12, it is positioned in a place that enables its free take-off and flight. The launch tube 78, which forms a drone assembly 10 together with the drone 12, is positioned upright, as shown in FIG. 5, with the three tripod legs 108 fully opened, i.e., positioned at a 90-degree angle with respect to the longitudinal axis A for enabling the launch tube 78 stability.

Since the drone 12 may be operated for various types of operations, its launching may take place from various places. Thus, the launch tube 78 may be positioned on soft ground, soil, uneven surface, sand, grass, concrete, or, attached to a pole or fence, positioned on a marine vessel like a boat or ship, positioned on the roof of a fire truck, and the like.

When it is required to operate the drone 12, first, the protective cap 114 of the power switch 112 is lifted and the power switch 112 is turned “on” thus providing power to the launch tube 78. Next, the arming and deployment switch 116 is pressed. The power switch 112 and the arming and deployment switch 116 do not have to be manually operated. According to some embodiments, the power switch 112 and the arming and deployment switch 116 are remotely operated, by wire or wireless by a mobile app, from a location that is remote from the launch tube 78.

According to some embodiments, the power switch 112 and the arming and deployment switch 116 are automatically and autonomously operated by (i.e., in response to) a signal received from an operating sensor (not shown). Such an operating sensor may be, e.g., a sensor which detects fire in the vicinity of the launch tube 78. Such an operating sensor may be located in a vicinity of the launch tube 78, remote from the launch tube 78, or, located within the launch tube 78 and being integrally operated therewith.

The drone 12 is provided with a built-in onboard AI chipset, therefore, after the operation of the arming and deployment switch 116, all the actions taken by the drone 12 are done automatically and autonomously.

First, the servo motor 104 receives a signal to operate the locking mechanism 98. Upon operation of the locking mechanism 98, the locking arm 100 rotates 90-degrees with respect to its locked position and leaves the locking groove 102. Now, since the first cap 84 is no longer attached to the second cap 86, they separate from each other and accomplish a 180-degree rotation around their corresponding hinge, i.e., the first cap 84 rotates about the first hinge 90 by means of the pre-loaded torsional spring 96 found within the first hinge 90, and, the second cap 86 rotates about the second hinge 94 by means of the pre-loaded torsional spring 96 found within the second hinge 94.

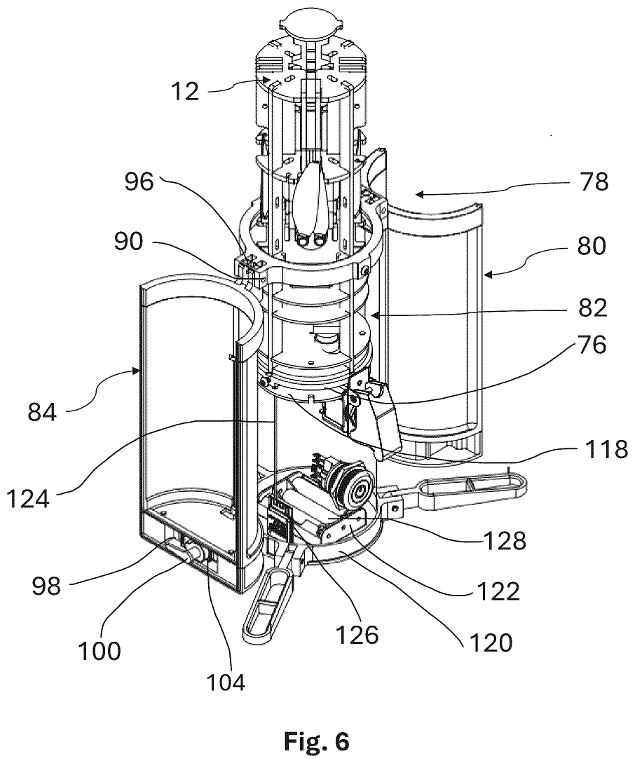

At this stage, as shown in FIG. 6, the launch tube 78 is open and the drone 12 is uncovered, peripherally exposed, and ready for operation.

At the next stage, which takes place simultaneously with the separation of the first cap 84 from the second cap 86, since the arms 30 are no longer restrained within the launch tube 78 by the first cap 84 and by the second cap 86, then, by the tension of the activating spring 72, the operating pin 58 is urged downwardly until the pin head 60 abuts against the upper base 20 of the drone 12. During the downward movement of the operating pin 58, each of the four toothed racks 62 rotates its mating toothed portion 56 of an arm 30. Thus, each arm 30 rotates a 90-degrees rotation, or almost a 90-degrees rotation, about its arm axis B and the drone 12 gets into a deployed position, as shown in FIG. 2.

In this manner, in a deployed position of the launch tube 78, the launch tube 78 is open and the drone 12 is peripherally exposed and capable of passing from an un-deployed position of the drone 12 to a deployed position of the drone 12 when the drone 12 still rests in the launch tube 78.

At this stage, when the arms 30 are fully deployed, or almost fully deployed, each of the electric motors 36 starts rotating about its motor axis C. At this stage, due to a centrifugal force exerted on each of the propellers 40, they rotate around their corresponding protrusion 38 about the protrusion axis E until they are directed away from the motor axis C. Now, by the combined rotation of the eight propellers 40, they provide an elevation force to the arms 30 and hence to the drone 12.

The elevation force provided by the propellers 40 to the deployed arms 30, and, a counter-weight provided by the drone 12, ensures a fully-deployment of the arms 30 into a fully deployed position in which the arms are directed perpendicularly to the longitudinal axis A and each motor axis C is parallel to the longitudinal axis A.

According to some embodiments, the drone 12 is provided with a latch (not shown) that locks the arms 30 when they got into a fully deployed position thus ensuring a consistent position of the arms 30.

According to some embodiments, the drone 12 is not provided with a latch that locks the arms 30 thus providing flexibility to the arms 30 with respect to the frame 14.

As explained above, the drone 12 has a rapid deployment and is airborne in under five seconds. Due to the built-in AI, the drone 12 autonomously handles launch, ascent, navigation, hovering, and descent to landing. Thus, the drone 12 takes-off autonomously and starts accomplishing tasks that it is designed to do. The built-in AI uses multiple sensors for navigation, including motion sensors for inertial navigation, camera looking at ground for optical flow, and object anchoring and identification for navigation.

The drone 12 is capable of autonomous vehicle tracking, thus, it may autonomously trail its launch vehicle, in a case where it has been launched from a vehicle.

Due to the built-in AI, the drone 12 is capable of autonomously locating and identifying human targets, or human targets holding weapons. According to other required functions, e.g., when it is required to detect a man that fall overboard from a marine vessel, the drone 12 autonomously detects the person in the water and hovers above the person while transmitting the location coordinates of the person until a rescue force arrives to the scene. In a case that more than one person was found, a decision to fly the drone 12 to a next person will be done autonomously by the drone 12, or, by a person that is in control of the video images received from the drone 12. By knowing the coordinates of the launch tube 78, the drone AI will calculate the coordinates of each person that is detected.

The drone 12 is able to autonomously search for humans in specific programmed areas. Such programmed areas may include, but are not limited to; shore lines, water strips beyond shore lines, one side of a fence or a wall, two sides of a fence or a wall, a perimeter of a given structure, trenches, specific buildings, and, a specific street.

Due to the built-in AI, the drone 12 is capable of autonomously locating and identifying specific targets that are detected by onboard sensors and systems, including cameras, thermal cameras, Radar, LIDAR, infrared x-ray, and the like. The specific targets that are detected include, for example, a tank, an armored personnel carrier (APC), a fighter plane, a helicopter, an unmanned aerial vehicle (UAV), a truck, a motorcycle, a machine gun, a rifle, a gun, a cannon, a mortar, a missile launcher, a grenade launcher like an RPG-7 (rocket-propelled grenade), a human holding a rifle/machine gun/missile launcher/grenade launcher, and the like.

The drone 12 provides video images and/or thermal images of a scene. Thus, it is advantageously applicable for a use by fire fighting teams that have a full image of the scene on fire and may adequately design the way of response, as soon as the fire truck arrives to the fire scene, when advantageously no pilot is required and no setup time is wasted in preparation for the flight. Thus, the drone 12 autonomously searches for fire and smoke, and upon detecting an area with fire or smoke, it hovers above the detected area or flies around it, for giving a 360-degrees thermal image of the detected area.

The drone 12 employs a wide angle lens, a built-in extra long-range antenna 124 within the launch tube 78, and, a Wi-Fi relay that relays the video from the drone 12 to the user. This is a major advantage of the drone assembly 10 of the present invention that the launch tube 78 serves as a video relay to the video images, sensor data and other telemetry information, filmed by the camera 74 of the drone 12, via local Wi-Fi, and/or ethernet, cellular to a local or remote user or directly to be stored in a remote network system.

Ethernet+PoE port sends video image via Ethernet to LAN or WAN endpoints.

The drone 12 utilizes rotating encryption keys for maximum security per drone.

The user is located remote from the drone assembly 10, and may see the video images, sensor data and other telemetry information, on a screen of a mobile phone, tablet computer, laptop computer, or PC.

Since the launch tube 78 serves as a relay station, it can record and/or buffer the video images, using on-board memory, so that if the user misses video images he can replay backwards the video images received from the drone 12.

The launch tube 78 and the drone 12 utilize a fountain code, or similar algorithm, that allows to recover missing packets due to bad signal or conditions.

The drone 12 uses cloud video processing AI. It is able to store all the recorded videos, to detect anomalies in recordings at similar locations across different dates, from multiple devices, and fuse video from multiple locations recordings to create a 3D virtual field view.

The drone 12 may be used in remote locations for securing perimeter fences of all kinds of facilities. In a case that a sensor is tripped, the drone 12 may be launched by a control room located far remotely therefrom or automatically when the sensor is tripped. Thus, in a case that a human is detected, the drone 12 hovers above the person and transmits its location. Furthermore, in a case when there are new objects or field changes on scene, the drone 12 may detect objects that were not there before.

The drone 12 may be used for continuous observation for securing border fences, walls, antenna towers, strategic facilities, and the like, without taking-off from the launch tube 78. In such cases, the launch tube 78 is provided with an upwardly directed conical mirror (not shown) which is located under the lower base 18 of the drone 12, and, with transparent covers around the conical mirror. Thus, the downwardly directed camera 74 is filming a sector of 360-degrees around the launch tube 78. The filmed images are transmitted to a remotely-located control room. The operators of the control room are provided with a program that transfers the fisheye view received through the conical mirror into a regular image view in computer screens. Thus, if the operators of the control room detect any suspicious action and require further look, they send a signal to launch the drone 12, and, from that point forward the drone 12 continues an autonomous operation as described above. Furthermore, if an object or anomaly that were not there before are detected, then, an alert is transmitted to the control room so that the operators of the control room may decide if it is necessary to launch a drone 12. Due to the very cost-effective value of the drone 12, many operation hesitations may be disregarded and a launch of a drone 12 may freely take place.

In some cases, where it is not required to observe a sector of 360-degrees but only a portion thereof, then, instead of the conical mirror, the launch tube 78 comprises one or more mirrors. The mirrors may be flat, or, curved according to specific needs.

The drone 12 according to the present invention embodies various advantages. The total weight of the drone is under 250 grams, therefore, it doesn't need to be registered with FAA. It maintains a visual line of sight using AI navigation. It is very safe to use, also with a lot of people around, since the AI navigation tries to avoid people or structures when descending. When descending, the drone operates strobe lights and a very loud buzzer in order to warn people in the vicinity of the landing site. According to the size of the battery 52, the drone may have an average flight time from 10 minutes to 45 minutes.

The majority of the drone 12 is made of recycled materials; wood and biodegradable plastics, therefore, it is inexpensive and may be used for a single use. However, the drone 12 may be recycled and reuse most of its parts.

The drone 12 embodies a special feature that, by operation of the power switch 112 and the arming and deployment switch 116 at the launch tube 78, the drone 12 is urged to be launched, even if no mobile phone, computer, tablet computer, or laptop computer are connected or paired to the drone 12.

The launch tube 78 and the drone 12 utilize an encryption scheme. The drone 12 has a stored root key. When the drone 12 is installed inside the launch tube 78 by a user, the user will scan a barcode, or via local wireless on the drone, containing a public key or rotating keys, local wireless or a barcode of the launch tube also containing a rotating public key, and provisioning a combo specific launch tube and specific drone. A cloud having public keys thereon will identify the specific public keys, compared to the public keys stored in the cloud, and root keys. Thus, a full encrypted rotating keys solution will be allowed, and, the operation of the drone 12 can be done only by connecting to the cloud and getting actual keys to decrypt a control of the drone 12.

The present invention also provides a system and method for securely provisioning and communicating between a drone and its associated launch tube using encrypted wireless connections. The system includes a unique root key encryption scheme for the drone and launch tube, with cloud-based key management to ensure secure data transmission and device provisioning.

The system comprises the following components:
(a) A drone: aerial vehicle equipped with video and sensor data capture capabilities, capable of connecting via Wi-Fi or other wireless system.
(b) A launch tube: enclosure for the drone that facilitates secure storage and launching, equipped with its own Wi-Fi connectivity, or other wireless system.
(c) A cloud service: centralized system for key management and device provisioning, storing encryption keys in a secure vault.

The provisioning process includes:
(a) Initial setup: users begin by scanning barcodes on both the drone and the launch tube using a mobile application. These barcodes contain unique device identifiers.
(b) The mobile application, authenticated and connected to the cloud service, uses these identifiers to initiate provisioning. It connects via the unsecured Wi-Fi networks of both the drone and the launch tube.
(c) Encryption key assignment: the cloud service generates a unique root encryption key for each device, which is then securely transmitted and stored in each device's memory.
(d) Key storage in cloud: once the keys are stored on the devices, the cloud service also save these keys in a secure cloud vault, mapping each device's ID to its corresponding key and recording the pairing of the drone and its launch tube.

### Operational Security:

(a) Secure connection establishment: after provisioning, the drone establishes a secure Wi-Fi connection with the launch tube using a hash of the launch tube's public key, ensuring the all communications are encrypted.
(b) Data encryption and access: all video, telemetry, and sensor data transmitted by the drone are encrypted using the drone's private key. Access to decrypt this data is controlled by the cloud service, ensuring that only authorized users can decode and view the data.

### Security Features:

(a) End-to-end encryption: utilizes end-to-end encryption for all communications between the drone, launch tube, and cloud service to protect against interception and unauthorized access.
(b) Secure key management: the cloud service manages all encryption keys, ensuring they are never exposed to external parties and are securely provisioned to each device.

The following is a description of the communications and control module (the Wi-Fi module) of the launch tube:

### Overview:

The communications and control module is integrated into a drone launch tube and comprises several key functionalities including communication relay, memory storage, and control mechanisms. The module can operate in four distinct configurations, each tailored to specific operational requirements and communication environments.

### Configurations:

### Configuration A—Wi-Fi to Wi-Fi Configuration

Functionality: relays the Wi-Fi signal to and from the drone within the tube to a controlling device (e.g., tablet, PC, mobile phone) enabling control and video feedback before, during, and after launch.

Components: Wi-Fi transceivers, memory unit for data storage, control unit.

### Configuration B—Wi-Fi to Ethernet Configuration

Functionality: converts and relays the Wi-Fi signal from the drone to an Ethernet connection, facilitating data transmission to a remote PC or cloud system for control and monitoring.

Components: Wi-Fi and Ethernet transceivers, memory unit, control unit.

### Configuration C—Wi-Fi to Cellular Configuration

Functionality: transmits the Wi-Fi signal to a cellular network, extending control and monitoring capabilities to remote locations via PC or cloud connectivity.

Components: Wi-Fi and cellular transceivers, memory unit, control unit.

### Configuration D—Hybrid Configuration

Functionality: combines elements of the above configurations (A and B, A and C, or A, B, and C) to provide adaptable communication solutions based on mission requirements.

Components: combination of Wi-Fi, Ethernet, and cellular transceivers, memory unit, control unit.

### Control Functionalities:

Drone charging: manages power supply to ensure the drone is fully charged prior to launch.

Status and health checks: continuously assesses the drone's operational status and system health.

Encryption engine: secures communications and data with encryption protocols.

Arming and launch: controls the arming sequence and triggers the servo relay to initiate drone launch.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the singular form “a”, “an” and “the” include plural references unless the context clearly dictates otherwise.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the present invention has been described to a certain degree of particularity, it should be understood that various alterations and modifications could be made without departing from the spirit or scope of the invention as hereinafter claimed.

The beams do not have to be made of wood and other material may be equally applicable, such as, e.g., PVC, aluminum, light alloy, titanium, carbon fiber, and the like.

The arm supports do not have to be made of wood and other material may be equally applicable, such as, e.g., PVC, aluminum, light alloy, titanium, carbon fiber, and the like.

The beam upper section does not have to be connected to the beam lower section by a puzzle-like connection and by gluing them together, and other methods of connection of the beam upper section to the beam lower section may be equally applicable.

The beams do not have to be constructed from two sections and they may be constructed as a single piece.

The upper base does not have to be in a shape of a flat disc that is generally round. Alternatively, the upper base may be formed as a flat ring.

The operation of the arms from a folded position to an unfolded position does not have to be carried out by a toothed portion, and other operation mechanisms that unfold the arms may be equally applicable.

The launch tube does not have to be provided with foldable tripod legs as disclosed above. According to other embodiments, stability of the launch tube is obtained by providing a magnetic surface at the bottom of the launch tube so that it could be attached to a metal surface like of a car, a fire truck, or a marine vessel.

Furthermore, the launch tube does not necessarily have to be provided with stability fixation means as described. Alternatively, the launch tube may be physically restrained to a hand-rail, pole, or the like, of a fire truck, marine vessel or the like, by means of a rope, cable ties, plastic or nylon restrains, and the like.

The securing of the first cap to the second cap do not have to done by a servo motor and other locking means may be equally applicable.

The power switch and the arming and deployment switch do not have to constructed or located as described, and other types of switches may be equally applicable and located according to design needs.

1. A drone assembly (10) comprising a drone (12) and a launch tube (78) therefor, wherein
in an un-deployed position of the drone assembly, the drone is stowed in a stowed position within the launch tube and the launch tube is closed,
in a deployed position of the launch tube, the launch tube is open and the drone is peripherally exposed and capable of passing from an un-deployed position of the drone to a deployed position of the drone when the drone still rests in the launch tube.

2. A drone assembly (10) according to claim 1, wherein
the drone (12) comprises a generally cylindrical frame (14) and a longitudinal axis (A), the frame comprises four beams (16) that extend between a lower base (18) and an upper base (20), an arm support (28) is connected between each beam and the upper base, an arm (30) is connected between each two adjacent arm supports, each arm is rotatable with respect to its adjacent arm supports around and arm axis (B) that is perpendicular to a plane passing through the longitudinal axis and through the arm, wherein
in an un-deployed position of the drone, the arms are positioned parallel to each other and to the longitudinal axis, and
in a deployed position of the drone, the arms are perpendicular to the longitudinal axis.

3. The drone assembly (10) according to claim 2, wherein
each arm comprises, in an inward portion (54) thereof, a toothed portion (56) that extends at a sector of 90-degrees,
an operating pin (58) is positioned between the toothed portions of the arms, the operating pin has a flat pin head (60) and four toothed racks (62) extending downwardly therefrom, each toothed rack conforms in shape and position to a toothed portion of an arm that is in contact therewith,
a tensioning bolt (64), having a bolt head (66) and a threaded portion (68) extending upwardly from the bolt head, is threadingly engaged into a lower portion (70) of the operating pin,
an activating spring (72) is compressed between the bolt head and the lower portion of the operating pin, wherein
in the deployed position of the launch tube, a tension of the activating spring urges the operating pin to a downward movement until the pin head abuts against the upper base of the drone, and wherein
during the downward movement of the operating pin, each of the four toothed racks rotates a mating toothed portion of an arm, and, each arm rotates a 90-degrees rotation about its arm axis, and the drone gets into a deployed position.

4. The drone assembly (10) according to claim 3, wherein
each arm (30) comprises an electric motor (36), having a motor axis (C), and two propellers (40) mounted thereon, and wherein
during a final deployment stage of the arms, an elevation force provided by the propellers to the deployed arms, and, a counter-weight provided by the drone, ensures a fully-deployment of the arms into a fully deployed position in which the arms are directed perpendicularly to a longitudinal axis (A) of the drone, and each motor axis is parallel to the longitudinal axis.

5. The drone assembly (10) according to claim 1, wherein the drone (12) comprises at least one camera (74) that provides video images and/or thermal video images.

6. The drone assembly (10) according to claim 1, wherein the drone (12) is provided with built-in AI for autonomously controlling launch, ascent, navigation, hovering, and descent to landing, and wherein
the built-in AI uses multiple sensors for navigation, including motion sensors for inertial navigation, camera looking at ground for optical flow, and object anchoring and identification for navigation.

7. The drone assembly (10) according to claim 1, wherein the launch tube has a power switch (112) and an arming and deployment switch (116) that enables launching of the drone even if no mobile phone, computer, tablet computer, or laptop computer are connected or paired to the drone.

8. A drone assembly comprising a drone and a launch tube therefor, wherein
the drone comprises an onboard AI chipset and onboard sensors, and wherein
the drone performs autonomously take-off and flight, searches for a pre-programmed target, and autonomously locate and identify specific targets that are detected via its onboard sensors.

9. The drone assembly according to claim 8, wherein
the drone autonomously searches for humans, and upon finding a human it hovers above the human that was found.

10. The drone assembly according to claim 8, wherein
in a case that more than one human was found, a decision to fly the drone to a next person will be done autonomously by the drone, or, by a person that is in control of video images received from the drone.

11. The drone assembly according to claim 8, wherein
the drone autonomously searches for humans in specific programmed areas.

12. The drone assembly according to claim 11, wherein
the specific programmed areas include amongst others; shore lines, water strips beyond shore lines, one side of a fence or a wall, two sides of a fence or a wall, a perimeter of a given structure, trenches, specific buildings, and, a specific street.

13. The drone assembly according to claim 8, wherein
the drone autonomously searches for fire and smoke, and upon detecting an area with fire or smoke, it hovers above the detected area or flies around it, for giving a 360-degrees thermal image of the detected area.

14. A drone assembly comprising a drone and a launch tube therefor, wherein
the launch tube comprises a built-in long-range antenna that receives video images from the drone, and
the launch tube relays the video images, sensor data and other telemetry information, via local Wi-Fi, and/or ethernet, cellular to a local or remote user or directly to be stored in a remote network system.

15. The drone assembly according to claim 14, wherein
the user is located remote from the drone assembly, and may see the video images, sensor data and other telemetry information, on a screen of a mobile phone, tablet computer, laptop computer, or PC.

16. The drone assembly according to claim 14, wherein
the launch tube, serving as a relay station with built-in memory, can record or buffer the video images, so that if the user misses video images the launch tube can replay backwards the video images that are received from the drone and stored on the launch tube.

17. The drone assembly according to claim 14, wherein
the launch tube and the drone utilize a fountain code or similar algorithm that allows to recover missing packets due to bad signal or conditions between the drone and the launch tube.

18. The drone assembly according to claim 14, wherein
the drone is used for continuous observation for securing specific areas without taking-off from the launch tube.

19. The drone assembly according to claim 18, wherein
the specific areas that are observed may include, amongst others, border fences, wall, antenna towers, and strategic facilities.

20. The drone assembly according to claim 18, wherein the launch tube comprises:
a mirror that is located under a camera of the drone,
a transparent cover of the launch tube, positioned between the mirror and the area to be observed, and wherein
the camera is facing downwardly and provides video image of the area to be observed through the mirror.

21. The drone assembly according to claim 20, wherein
the mirror is formed as an upwardly directed conical mirror having a vertex of the cone located below the camera,
the transparent cover of the launch tube extends around the conical mirror, between the conical mirror and the area to be observed, and wherein
the downwardly facing camera provides a video image of an area of 360-degrees or less, around the launch tube.

22. The drone assembly according to claim 14, wherein
the launch tube and the drone utilize an encryption scheme, wherein
the drone has a stored root key,
when the drone is installed inside the launch tube by a user, the user will scan a barcode, or via local wireless on the drone, containing a public key or rotating keys, local wireless or a barcode of the launch tube also containing a rotating public key, and provisioning a combo specific launch tube and specific drone,
a cloud having public keys thereon will identify the specific public keys, compared to the public keys stored in the cloud, and root keys,
thus, a full encrypted rotating keys solution will be allowed, and wherein
the operation of the drone can be done only by connecting to the cloud and getting actual keys to decrypt a control of the drone.

23. A method for securely provisioning the drone and the launch tube of the drone assembly according to claim 14, using cloud-managed root keys, for ensuring secure initial setup and operational communication.

24. A system for encrypting and securely transmitting data from the drone of the drone assembly according to claim 14, utilizing unique device-specific encryption keys managed centrally by a cloud service.

25. A communications and control module, for the drone launch tube of the done assembly according to claim 14, capable of multiple communication configurations: Configuration A—Wi-Fi to Wi-Fi configuration, Configuration B—Wi-Fi to Ethernet configuration, Configuration C—Wi-Fi to cellular configuration, Configuration D—Hybrid configuration.

26. A method of controlling drone launch and communication as described in configurations A, B, C, and D of claim 25.

27. A drone launch system comprising a launch tube, a drone, and the communications and control module according to claim 25.
